(19) United States
(12) Patent Application Publication
(10) Pub. No.: US 2010/0131296 A1
(43) Pub. Date: May 27, 2010

(54) Internet Health Data System

(76) Inventor: Roger C. Knutson, Indianapolis, IN (US)

Correspondence Address: BOWMAN & ASSOCIATES, 1016 3rd Avenue, SW, Suite #106, CARMEL, IN, 46032, US

(21) Appl. No.: 12/538,599

(22) Filed: Aug. 10, 2009

Related U.S. Application Data
(63) Continuation of application No. 10/903,629, filed on Jul. 30, 2004, now abandoned.

(51) Int. Cl. G06Q 10/00; G06Q 50/00; G06F 17/30

(52) U.S. Cl. 705/3; 707/802; 707/741; 707/769; 707/E17.045; 707/E17.002; 707/E17.014; 707/E17.055

(57) ABSTRACT

An Internet based health data system for providing patient medical, health, insurance and related data via the Internet, to a plurality of potential users including the patient based on profile and security that complies with all regulations including the HIPAA Act. The system registers and maintains an individual's health data by adding a meta-data wrapper thereto that then determines applicability-to-use cases defined by system logic. A patient profile is also used to recommend and independently search the Internet for appropriate information to benefit the patient and potential stakeholders and caretakers of the patient. Each profile and related data is interactively developed with regard to the individual patient and the other participant users including physicians, insurance institutions, hospitals, laboratories, family genetics, health care facilities, government agencies, etc. and stored in a relational database to be continuously updated through a patient's lifetime. The profiled health material is converted into contemporary, multi-tiered object oriented content utilizing Internet browser technology (i.e. HTML, VRML, HTTP/IIOP, Visual Basic, Active X, XML, RDF, Java-script, etc.) and integrated to the presentation level using object oriented technology and standards (e.g. OODBMS, Java, .jt, SQL, SOAP, CORBA, OLE, COM, etc.). The system is patient centric with a free web interface provided to the individual. Financial support is derived from the other stakeholders that can use this data. The system will constitute a single source of patient data that is secure and immediately accessible over the WWW to the appropriate stakeholders. The data is registered to the system and does not necessarily need to reside in a separate duplicated environment. All this data is converted in real time for standards based viewing across the WWW using standard browser technology.

### RELATED APPLICATIONS

This patent application is a continuation of co-pending U.S. patent application Ser. No. 10/903,629 filed Jul. 30, 2004 entitled “Internet Health Data System” the entire contents of which is specifically incorporated herein by this reference.

### COMPUTER PROGRAM LISTING ON CD

A computer program listing appendix of an object oriented database of metadata implementing the present invention was submitted on compact disc (CD-R), including a copy thereof, with parent patent application Ser. No. 10/903,629, the CD-R containing files named LIFELINE WORKITEM OBJECT MODEL 2-12-2004RCK.vdx and LIFELINE WORKITEM OBJECT MODEL 2-12-2004RCK.htm which were created on 2-12-2004 being 6.267 megabytes and 18 KB respectively, is included, the contents of which is hereby incorporated by reference herein, each in their entirety, and to the entire CD-R.

### BACKGROUND OF THE INVENTION

1. Field of the Invention

The present invention relates to a system for providing patient medical, health, insurance and related data via the Internet, to a plurality of potential users including the patient based on profile and security that complies with all regulations including the HIPAA Act.

2. Background

Previous generations may have had a single family doctor and limited need for collaboration with specialists, pharmaceutical companies, insurance carriers, etc. Today, however, the individual's health data is growing exponentially. There are seemingly conflicting objectives of security and access to many stakeholders. In addition to the individuals right to his health data and that of his family, the human community can also benefit from a window into this information.

In a report released Mar. 1, 2004, the Institute of Medicine (IOM) of the National Academies states:

“Reorganization and reform are urgently needed to fix what is now a disjointed and inefficient (health care) system.” The report further adds, “Use of information technology is key.

“The committee believes information technology must play a central role in the redesign of the healthcare system if a substantial improvement in quality is to be achieved over the coming decade.”

It is clear from the report's mandates that just any IT investment will not enable health care organizations to cross the quality chasm. In fact, the disparate systems approach of the past has actually contributed to the fragmentation and feeble information management that the IOM study sites that only an integrated architecture that spans the entire healthcare organization and throughout the community into the homes of consumers will meet this need. The Internet Solution herein will reach out and embrace the potential that exists today for fundamentally restructuring and improving the entire health process.

In “Crossing the Quality Chasm,” the IOM committee calls for strong and quick action from many sides. One of those recommendations speaks to one of health care's most overwhelming inefficiencies—paper-based clinical systems.

“Congress, the executive branch, leaders of healthcare organizations, public and private purchasers, and health informatics associations and vendors should make a renewed national commitment to building an information infrastructure to support healthcare delivery, consumer health, quality measurement and improvement, public accountability, clinical and health services research, and clinical education. This commitment should lead to the elimination of most handwritten clinical data by the end of the decade.”

The IOM report asks for new and improved policies of quality measurement as well as financial subsidies that will enable all health care organizations to conform to IOM guidelines.

“An improved information infrastructure is needed to establish effective and timely communication among clinicians and between patients and clinicians.”

“Sophisticated clinical decision support systems will be required to assist clinicians and patients in selecting the best treatment options and delivering safe and effective care.”

It is thus an object of the present invention to provide a health data system that is easily accessible to patients and health care providers.

It is thus another object of the present invention to provide an Internet based health data system for use by patients, health care providers and professionals, as well as diagnostic health service providers.

### SUMMARY OF INVENTION

The present Internet health data system allows for security and access for the patient or individual, the health care provider and/or professional, and the health care diagnostics providers. The Internet health data system is implemented in software that is built on standard Web-based tools and is accessible over the Internet. The present Internet health data system will provide a single source for all patient health data securely available thru a single website. This website will link global teams of health care providers such as doctors, specialists, administration, fulfillment, diagnostic etc. in order to provide the best possible care and treatment via readily accessible and current health care data.

Real-time access to all the patient health data will reduce risk of a misguided diagnosis or improper prescription. Unnecessary repeat testing can be avoided by relying on laboratory results that are still valid.

The present Internet health data system would appeal to a variety of individual, even if an individual did not have insurance, as they would still want the ability to manage/archive and secure their valuable health data or information. A patient software interface will be provided, preferably at no expense, to the individual as a WWW browser download. The present Internet health data system is designed to be “patient centric” and relies on initialization by the individual. Financial support options are varied and discussed later in this document.

The Internet health data system is built from existing web-based tools such as Oracle, SQL, Web application severs, Internet browsers, Teamcenter™ Enterprise, and behavior extensions that are represented by the Internet Health Data System Object Model (IHDSSOM) as per the principles of the subject invention.

The present Internet health data system is designed to eliminate inefficient and error-prone paper processes through a fully integrated infrastructure that not only ensures consistent care among clinicians, but also supports the improvement of consumer health and quality measurement.

The present Internet health data system links patients and their health care providers via secure Internet connections. Personal health record capabilities empower people to be proactive in maintaining good health and gives easy, quick access to various patient health data such as vital patient data, lab results and drug interaction checking. With this technology, health care organizations can not only meet the IOM's and HIPAA mandates for improving consumer health, but also provide themselves with a valuable business strategy for the 21st century.

Illustrations follow that give a high level view of the components and infrastructure of the present Internet health data system. A key element is the nature of the information uniquely retained by the program logic.

Let's navigate through an example:

A data object that is patient information like an x-ray, prescription, diagnosis etc. is registered to the present Internet health data system. This means that this data is tagged in a specific way with XML metadata. This allows for an assortment of retrieval and search conditions. One of the most important is that this patient data is known to exist in the database it is registered in. If it is moved it will be registered to the new location. This data is unique. It does not need to be copied and stored again at some other location. The present Internet health data system maintains this information as a relationship in the object model.

When you view data of this type you are viewing an image file or a rendering of this data. The view can be marked up for collaboration purposes, but the underlying data remains unchanged. The mark-ups themselves are logically attached to the appropriate data element as a separate document object.

The metadata described above is captured as a relational object that is linked to the individual patient. It is the relationships that are stored and managed by the present Internet health data system. The present object model of the Internet health data system describes many of the relationships and their connectivity to each other. Search and retrieval on this data is structured for Bayesian search techniques via relational dependencies that acquire probabilistic characteristics. These specific characteristics are added to the metadata based on the collective knowledge that can be determined from the enterprise database.

Security and access is controlled and granted through existing standards with state of the art user and password conventions. User classifications are used to allow specified views of the data that equate to a user profile. For instance, hospital check-in would be automated via the present Internet health data system as a download to hospital admissions personnel. The information provided to the hospital is uniquely formatted and organized for their system consumption. This same paradigm would exist as views for insurance companies, doctors, surgeons, nurses, dentists, government agencies, statistical evaluation, emergency scenarios, etc. This security model complies with the HIPAA—the Health Insurance Portability Act passed in 1996. Under this Act institutions, for instance, will be required to track every time a patient record is transferred electronically, by any means—or any medium. Institutions are required to comply with this legislation by April 2005. The present Internet health data system automates this security provision and allows for patient data access expediently.

Fixed Content: Example Information Retained for Active Reference

| | | |
|---|---|---|
| Contracts | CT Scans | Blood Work |
| Diagnosis | Clinical trial results | Environmental Data |
| Document Images | Digital evidence | Proteomic data |
| Email & attachments | Genomic data | Genealogy data |
| Legal Documents | Government records | Spreadsheets |
| Audio Conference | Historical documents | Training materials |
| Backups | Insurance photos | Transcripts |
| Biometric Data | Letters | Video conferences |
| Blueprints | Manuals | Videos |
| EKG | Monthly reports | White papers |
| Allergies | MRI's | X-rays |
| Photos | Insurance | Psychological Data |

5. The benefits of the present Internet health data system are immediate and will increase over time. The most obvious is for the individual, his family, and the lives that can be saved by providing all pertinent patient information data in real time across the planet over the Internet.

Other benefits include:

| | |
|---|---|
| Single logical data base for | Insurance companies need not |
| all patient data, instantly | redundantly store this information. |
| accessible over the Internet | Reduction in malpractice due to data |
| | availability and workflow |
| Decrease time for clinical | Drug interaction and benefits can be |
| studies | accessed on larger populations |
| Retention and protection | Health care management is simplified |
| of medical data | and indexed for classification |
| Drug therapy can be refined | Drug could be provided automatically to |
| and automated | the individual and tracked for |
| | manufacturing and supply chain. |

In addition to a single source of patient health information the present Internet health data system will provide authoring tools specifically designed for the stakeholders providing or extracting information.

For example: The patient will be able to download a web browser based tool designed predominately in XML to capture information that will be registered into the present Internet health system. This interface would be very straightforward and capable of uploading information to the present Internet health data system database for permanent records and potential verification by other stakeholders, i.e. Physicians, hospitals, etc.

The primary care physician (PCP) would have a similar environment specifically designed to automate the capture of patient records that are their responsibility, examples of which would include: medication prescribed; results of physicals; medical history; and patient referrals & scheduling.

A combination of automation tools can be used for this data input including, scanners, voice input, video, etc., while file formats like .PDF; TIFF, .JPG etc can be employed. All of this data is registered via a meta-data association and logically related to the other pertinent data as the Patient Internet Record —PIR. The PIR maintains this information in an evolutionary profile, where the timeline of patient activities is automatically registered to form a complete life history.

The security and viewing constraints for patients and PCPs are intentionally not very restrictive, however; other stakeholders' interaction with the Internet Solution will be limited to necessary information as required by a stakeholder profile. For example, insurance companies can bill and reimburse using the present Internet health data system. They would however, not be entitled access to information that is proprietary to the patient and or the PCP. Additional stakeholders can have a view of this data that is restricted to their profile. This could include gathering statistical information by health providers, pharmaceutical companies, government agencies, research institutes, etc.

After sufficient patient data resides in the present Internet health data system, the system can be extended to include patient workflow and notification. In other words, patient appointments and physician procedures can be maintained in the present Internet health data system. For example, a patient would be checked into ER automatically through user name, password and or fingerprint eliminating the usual Q & A process. Patient records would be available immediately through the WWW for hospital and administration to schedule patient care, physician interaction and all other vital hospital procedures. Not only would this serve as permanent record of prescribed care but also will be used for personnel notification via wireless technology. Many hospital caregivers will have a wireless handheld device to prompt them through daily care giving activities. In addition to the obvious benefits from traditional modes of operation in a mass emergency this quick transfer of information would be essential.

In response to the latest report entitled “IOM's Ten Rules to Redesign and Improve Care”, the present Internet health data system could offer the following benefits:

Care based on continuous healing relationships.

The present Internet health data system offers a scalable, enterprise-wide clinical solution to enable a lifetime of care management by a multidisciplinary team of caregivers. Our Web-based graphical user interface (GUI) offers secure, Internet communication between consumers and caregivers.

2. Customization based on patient needs and values.

The present Internet health data system is uniquely patient-centric, containing a person's demographic and clinical data in a single, consolidated digital medical record. With this comprehensive view of a patient's clinical as well as religious and cultural preferences, the care-giving team can customize care plans and better anticipate a person's needs.

3. The patient as the source of control.

The present Internet health data system puts greater health care control in the hands of consumers. With its personal health record capability, health care consumers have ready access to their complete health information and a variety of consumer-oriented health care knowledge resources so they can better manage and participate in their own health care decisions.

4. Shared knowledge and the free flow of information.

Capitalizing on the present Internet health data system's single source of data, consumers and their caregivers have unencumbered access to vital information such as lab results and prescription refills. Plus, consumers can take medication safety into their own hands with quick, easy access to the powerful drug-checking capabilities of a drug database maintained by the present Internet health data system.

5. Evidence-based decision-making.

The IOM's point of basing care on the “best available scientific knowledge” is a cornerstone of the present Internet health data system. The present Internet health data system will allow health care organizations to draw from expert decision support by integrating identified best practices, industry guidelines and patient information into one, central repository accessed across the care continuum. By automating these guidelines across the organization, providers can ensure consistent, appropriate care for every patient encounter. Because variance and outcomes data are captured as a by-product of the care process, performance measurement and organizational learning enable an evidence-based practice model.

6. Safety as a system property.

The present Internet health data system is committed to creating a culture of safety supported by proactive and preventive technology solutions. Expert decision support systems of the present Internet health data system can prevent and intercept avoidable medical errors including adverse drug events (ADEs). Built in assessment tools, such as an automated Braden Scale for skin assessment or the Halls risk assessment, are enriched with clinical decision support for proactive prevention and consistent management of high-risk patient conditions

7. The need for transparency.

Patients and their families are entitled to a complete and accurate report of a care providers' performance on safety, quality and overall satisfaction. Performance data is captured by the present Internet health data system and allows for rapid analysis and communication. The present Internet health data system's profiling feature will enable organizations, health providers/professionals and patients to track progress in reducing adverse drug events.

8. Anticipation of needs.

The IOM calls for proactive, not reactive care. The present Internet health data system enables proactive care through automated risk assessment and protocol automation tools that enable caregivers to well anticipate the needs of patients and plan their care accordingly. A single, integrated Patient Information Repository (PIR) of the present Internet health data system gives clinicians all the information they need at the point of care—literally at their fingertips all the time. The present Internet health data system's powerful technology is also poised to support innovative, up-and-coming predictive medicine stemming from recent genomic research.

9. Continuous decrease in waste.

The present Internet health data system addresses concerns over wasted resources and clinician time through powerful solutions that improve overall operational performance. By automating time-consuming tasks such as gathering patient information, entering orders, and documenting and coordinating care, the present Internet health data system will streamline clinician workflow so they have more time for their most important role—caregiver. Duplication of services and information can be eliminated or reduced, so that once an entry is made into the present Internet health data system that entry is accessible anytime, anywhere. Many Internet health data system clients should be able to achieve paperless environments, automating care processes to the point that administrative redundancy is mostly eliminated and time spent on data gathering and reporting is greatly reduced.

10. Cooperation among clinicians.

The collaborative integration of The Internet Solution stakeholders allows the digital medical record to span the continuum of care and be easily accessed remotely via the Internet. This connectivity and process automation enable multidisciplinary care management across the continuum of care. Clinicians and institutions can share knowledge, advance clinical research and collaborate on individual patient cases from literally anywhere in the world.

Key Internet Health Data System Services and Architecture Components:

From the Object Model

Foundation Components

Application Map

System Preference Files

JSP Pages

Text Bundles (localization)

Request Components:

Response Chains

Action Chains

Action Components

7. Extensibility:

Configure application flow via Application Map

Configure user interface via System Preferences

Change colors and fonts via HTML style sheets

Change page layout via JSP Pages

Change specific text messages via Text bundles

Expose new classes and attributes

Create new web functionality (via Action Components)

Expose new business logic

Enterprise Services and/or Enterprise tier methods

8. Client Tier

Thin—html, JavaScript, Active-X/Java Applets, HTTP/s, MSOffice i/f,

PLM Vis

Rich—Java, SOAP, HTTP/s, PLM Vis

9. Middle Tier

J2EE—M/V/C, Servlet, JSP, XML/XSLT, Beans, Java, MS .Net, SOAP,

Web Services, CSS

Leading Web Application Servers

BEA, IBM, Sun, Oracle, MS, Apache

Security/LDAP

Sun, Oracle, MS, IBM

10. Enterprise Tier

C/C++, ORB

11. System Tier

Unix, Win, Linux*

SQL*Server, Oracle

TCP/IP

3^{rd} parties—Adobe, MSO, Autonomy, Tessellation/CAD

12 XML Data

Representation

Reporting Framework & Reports

Client PS & JT Visualization

BOM Package Export/Import

13. Internet Solution Common Services

Tessellation/Translation Services

Security—Authentication & SSO

Option & Variant Engine

Index & Search Engine

Conferencing Server

14. Control Intellectual Capital

15. Who needs access (user, group, team, role)?

16. What objects to access?

17. When does the individual need access?

18. What action needs to be performed?

19. Security Infrastructure Goals

20. Application independence

21. Standard security (authentication, authorization, entitlement) services

22. Ease of administration

23. Leverage existing authorization systems

24. Provide audit reporting 25. User/Password

26. Authentication & Authorization (LDAP, SSO)

27. Access Control

28. Ownership

29. Sharing

30. DRM/IP

31. Expiry

32. Access Entitlement

33. Rules and access control lists (ACL's)

34. Business Items

35. Attributes and metadata records

36. Data Items

37. Documents, CAD Models, Visualizations, files

38. Export Control/ITAR, Distributed access (TAA; s)

39. Access Collections

40. Vaults—Encryption

41. Teams—Membership/role

42. Objects—Access, Digital Rights Mgmt (IP rights)—expiry

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a representational block diagram of an exemplary system incorporating the principles of the subject invention;

FIG. 2 is a representational diagram of the computing infrastructure of the subject Internet health data system;

FIG. 3 is a representational diagram of the framework logic of the subject system;

FIG. 4 is an exemplary program interface for the subject system;

FIG. 5 is a block diagram of an exemplary system in accordance with the principles of the subject invention;

FIG. 6 is a flow-chart of an exemplary manner of operation of the subject invention;

FIG. 7 is a diagram of an exemplary embodiment of the subject system utilizing J2EE application servers;

FIG. 8 is a diagram of an exemplary architecture of a portion of the system of FIG. 7;

FIG. 9 is a diagram of a portion of system flow or a manner of operation of the subject system of FIG. 7 in accordance with the principles of the subject invention;

FIG. 10 is an example of existing patient data organization;

FIG. 11 is a diagram of information components of the present system;

FIG. 12 is a diagram of an object relationship model of the present system;

FIG. 13 is a diagram of a further portion of system flow or a manner of operation of the subject system of FIG. 7 in accordance with the principles of the subject invention;

FIG. 14 is a diagram of a further portion of system flow or a manner of operation of the subject system of FIG. 7 in accordance with the principles of the subject invention;

FIG. 15 is a diagram of a further portion of system flow or a manner of operation of the subject system of FIG. 7 in accordance with the principles of the subject invention;

FIG. 16 is a diagram of a further portion of system flow or a manner of operation of the subject system of FIG. 7 in accordance with the principles of the subject invention;

FIG. 17 is a block diagram of another exemplary system in accordance with the principles of the subject invention;

FIG. 18 is a block representation of the object model database of the exemplary system in accordance with the principles of the subject invention;

FIG. 19 is a flowchart of an exemplary manner of providing patient health material in accordance with the principles of the subject invention;

FIG. 20 is a diagram of a further portion of system flow or a manner of operation of the subject system of FIG. 7 in accordance with the principles of the subject invention; and

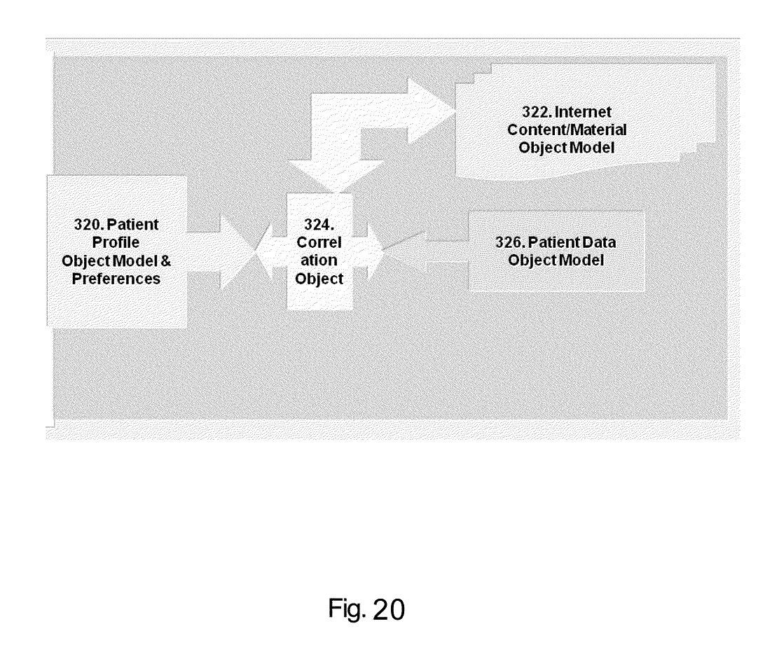

FIG. 21 is a diagram of a further portion of system flow or a manner of operation of the subject system of FIG. 7 in accordance with the principles of the subject invention.

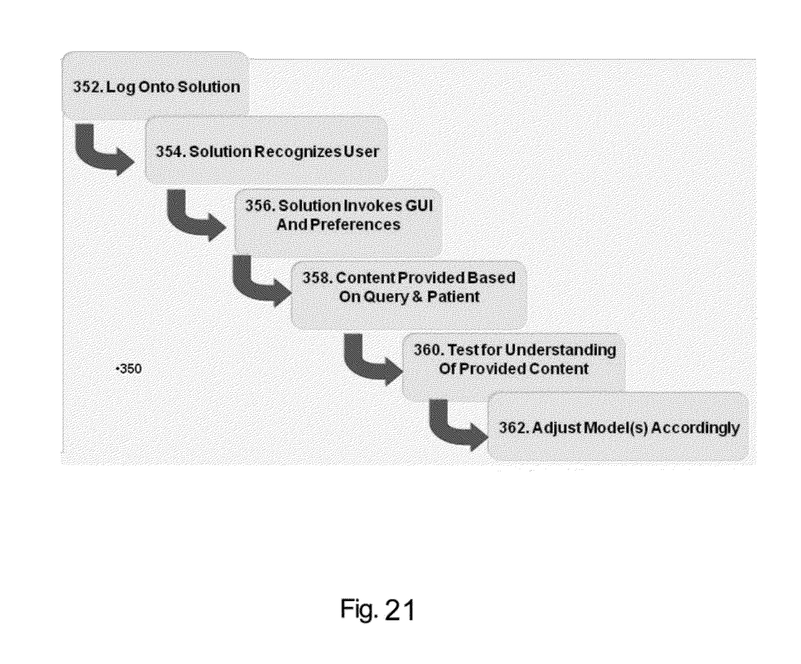

Corresponding reference characters indicate corresponding parts throughout the several views.

### DETAILED DESCRIPTION OF THE INVENTION

As used herein: 1) The term Health Profile is used to depict the broad assortment of information such as wellness, environment, life-science data, family, administration, reports, MRI's, genomic data, laboratory tests, diagnosis, physicals, x-rays, psychological data, EKG's, allergies, insurance, audio/video data, etc. that constitute an individuals complete spectrum of health related data; and 2) The term ebot or spider is a software agent/program that is deployed to perform tasks on the Internet without direct guidance. Ebots perpetually navigate the Internet performing complex tasks such as abstraction, encapsulation, modularity, reusability, concurrency and distributed operations. In the framework of the present Internet system, an ebot is used to search, catalogue, classify and/or categorize Internet content into packets of data according to individual life science proclivities and/or preferences. This knowledge agent will automatically gather information and map it into the appropriate format (i.e. language, disability, retention style, etc.).

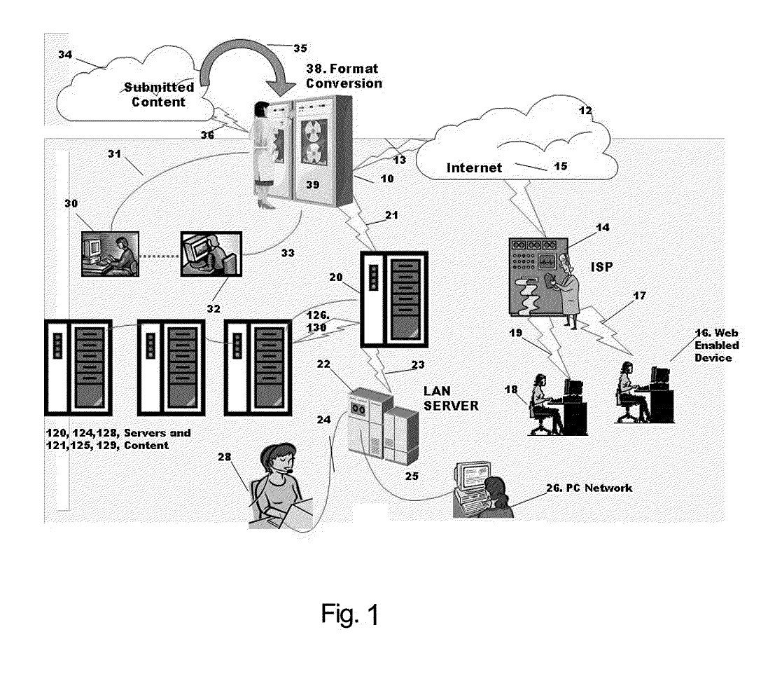

Referring now to FIG. 1, there is depicted a representation (e.g. block diagram) of an exemplary embodiment, generally designated 1, incorporating the subject invention in accordance with principles presented herein. A server/database/system 10 as is known in the art represents the present Internet health data System/Program (hereinafter “system’) being a logical system and database. The system 10 may be many individual systems networked to one another rather than a single system.

The system registers and maintains the individual's health data by adding a meta-data wrapper that then determines applicability to use cases defined by the system logic. Registration in the solution results from Bayesian logic parsing to match search and corresponding content relationships. This allows for broadly based search with many levels of stakeholder correlation. A patient profile is also used to recommend and independently search the Internet for appropriate information to benefit the potential stakeholders and caretakers of the patient. The patient using a free, downloadable, web-based software tool generally provides this profile content. Over time this profile will evolve and become validated by various stakeholders. The Primary Care Physician (PCP) is materially involved in determining and recording accurate data for the patient. Material gathered from the Internet and submitted content is filtered, coordinated, and indexed to each individual's profile template. Each profile and related data is interactively developed with regard to the individual patient and the other participant users including physicians, insurance institutions, hospitals, laboratories, family genetics, health care facilities, government agencies, etc. and stored in a relational database to be continuously updated through an patient's lifetime.

The system is patient centric with a free web interface provided to the individual. Financial support is derived from the other stakeholders that can use this data. The system will constitute a single source of patient data that is secure and immediately accessible over the WWW to the appropriate stakeholders. The data is registered to the Internet Solution and does not necessarily need to reside in a separate duplicated environment. All this data is converted in real time for standards based viewing across the WWW using standard browser technology.

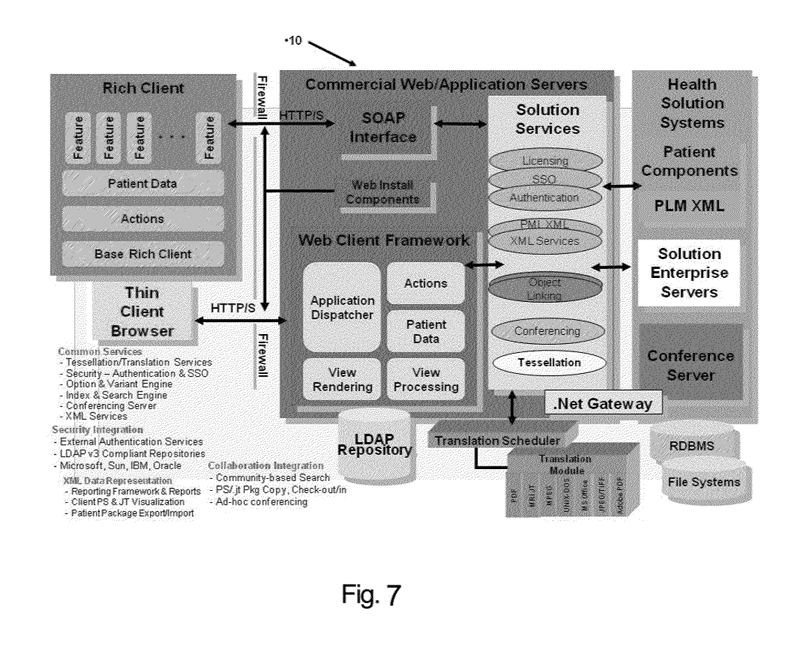

The system 10, also described in FIG. 7 is configured, operative and/or adapted to obtain and/or create a health profile for an individual or user, search the network, Internet or the like for health material/content, obtain data regarding the material/content which may include cataloguing, classifying and/or categorizing the material/content, correlate the health material data to a user health profile for providing the material/content to the user in accordance with the health profile, testing the user, redefining the correlation between the health profile and the material/content, and more as described herein. The individual health data consists of still pictures or frames, video clips, audio clips, written documents, x-rays, CAT Scans, prescription data, insurance data and/or any other type of multi-media formatted information/data catalogued from physicians, hospitals, insurance, etc.

As well, the Health Profile includes submitted content 34 that are forwarded to the system 10 by third parties who desire the material to be included and/or registered. The submitted content 34 may be forwarded via electronic means as signified by the bolt 35, or by other means as signified by the arrow 36. As with all material, the submitted data is evaluated for security, suitable content, indexed, and linked to the individual health profile characteristics, preferences and/or proclivities. This object-oriented fabric of the system 10 then serves to push data (provide the material) appropriate to the individual based on the professional profile of that user. A program director (i.e. a group of individuals or a single individual) or a programmable/automatic agent (i.e. a computer program) acts as a filter and coordinator of material/information tailored for the individual use while the Internet program specifics will be used to assemble the information/data.

The submitted content 34 may need to undergo format conversion 38 before storage in the system 10. Such format conversion 38 may be scanning via a scanner (not shown) of a document or documents. Format conversion 38 may also be conversion from, for example, “JPEG” to “GIF” formats, or similar format conversion.

With submitted content 34, the originator and/or supplier could be charged a fee to consider and/or use the content within the context of the Internet Program. An ongoing fee for use of the submitted content (now registered as System material, assuming the same is approved for use by the program director/programming agent and patient) could be calculated based on the number of times the material is accessed. Of course, other schemes for calculating fees for use may be used.

As well, the system 10 is connected to the Internet 12, as signified by the line 13, in order to obtain resource(s), material(s), and data (collectively “content”) available via the Internet 12. This is represented by the server 120, the server 124, and the server 128 (the servers 120, 124, and 128 thus representing all or the plurality of the servers or the like of the Internet 12, while the content 121, 125, and 129 represent all of the material/content of the Internet 12). The server 120 contains content 121 that is accessible to the system 10 via the connection 122 via the Internet 12. The server 124 has content 125 that is accessible to the system 10 via the connection 126 via the Internet 12. As well, the server 128 has content 129 that is accessible to the system 10 via the connection 130 via the Internet 12. The content 121 may be the health information or the like and is obtained from the various servers by the system 10.

In accordance with an aspect of the subject invention, the system 10 gathers content or material from the various servers via the Internet 12. Particularly, the system 10 looks for specific content from the Internet 12 based on health related, or informational need of a user. The health profile of a user may be consulted to seek the particular content. The content is then gathered by the system 10 and then stored thereon. More particularly, the system 10 may utilize a semantic engine to seek and retrieve content that is appropriate for the particular user. The content/material may be stored as data regarding the content, elements or characteristics of the content, or both. The user may, according to an aspect of the subject invention, provide various queries for information via a graphical user interface (GUI). In another instance, a specific patient health profile may seek and select the appropriate content from the Internet 12. In both cases, the user's health profile is preferably utilized to correlate the gathered content to the specific user.

Internet may also provide management of the content sought, gathered or collected, and provided to the user. A patient may receive information in a form adapted to his level of understanding, where a physician and/or surgeon would be provided information at an advanced level. Since the content from the Internet 12 is typically in a “raw” form, the gathered content may need to be filtered before it can be provided to the user. The content may not be appropriate for a user for various reasons, such as age problems, health progress or visual problems, or the like. Filtering may include editing the content so that it is suitable for the user in the various respects noted above, as well as for the information or health content thereof. Filtering may also include providing only some of the content from an Internet page or site. Further, the content may be evaluated for suitable content, indexed, and linked to template or profile characteristics. The program director or programmable agent would as well, review the content before making the same available as provided content. Since the content from the Internet 12 is free, there is no fee charged to an Internet (web) site for its use. A web site may, however, be charged for content use depending on the circumstances.

The Internet material or content that is chosen, selected, or gathered in response to the system 10 needing to obtain content for providing information to a user is processed by the system 10 according to the user's profile. The content may be stored on the system 10. The system 10 also formats, reformats, or converts the content in accordance with the user's profile and/or the user's hardware profile such that it is provided in a format or level that is appropriate to the user. This typically involves formatting into contemporary, multi-tiered, Internet browser technology using HTML, VRML, HTTP/IIOP, Visual Basic, Active X, Java-script, XML and the like. Further this may involve integrating the content to the presentation level using object oriented technology and/or web tools such as OODBMS, Java, SQL, Oracle, CORBA, OLE, Websphere™ Metaphase™, and the like.

As depicted in FIGS. 1&7, the presentation level material (content provided by the system 10 to the user) from the system 10 may be accessed by or via an Internet Service Provider (ISP) server 14 shown as in electronic communication with the server 10 via the internet 12 as indicated by the bolt 15. The system 10 would have an Internet address such as “http://www.Internet.org/. A home personal computer (PC), workstation, or web-enabled device 16 (collectively “PC”) is electronically connectable to the ISP 14, as signified by a line 17, via any known means (e.g. modem, ISDN, cable modem, satellite, TI connection, or the like). As well, the PC 16 may be a custom “system” device. The PC or Web 16 preferably runs an Internet browser as is known in the art or a custom system platform. The PC 16 is thus adapted to receive content or Internet material on the presentation level as described above through the system or Internet HTML/Java/XML/etc. program. As well, the PC 16 would be able to run the System GUI as explained below. The System GUI allows the user to formulate content requests that the system 10 would carry out in the same manner as the system 10 gathers and processes any content in accordance with the present principles.

A plurality of PCs as indicated by a second PC 18 is electronically connectable to the ISP 14, as signified by a line 19, via any known means (e.g. modem, ISDN, cable modem, TI connection, or the like). As well, the PC 18 may be a custom Internet device. The Web 18 preferably runs an Internet browser as in known in the art or a custom Internet platform. The PC 18 is thus adapted to receive content or educational material on the presentation level as described above. As well, the PC 18 is configured/adapted to run the System GUI.

There are other means to access the Internet system 10 as indicated by server 20 in semi-direct electronic communication (not via the Internet) with the Internet server 10 as indicated by the line 21 via any known means (e.g. modem, ISDN, cable modem, TI connection, or the like). Additionally, a remotely located LAN/WAN or other network server 22 may be in electronic communication with the server 20, as indicated by the line 23 via any known means (e.g. modem, ISDN, cable modem, TI connection, or the like). Representing a plurality of networked PC's are PC 26 and PC 28 coupled via network 24. This may represent a hospital, doctor's office, insurance business, or other network environment that can gain access to the Internet system 10 and use the Internet Program/System as described herein.

Further, additional PCs 30 and 32 may be directly coupled to the Internet system 10 via a network or individually. These PCs may all connect to and allow participation with the Internet system in accordance with the subject principles. Anyone who has access to such a web-enabled device may therefore gain access.

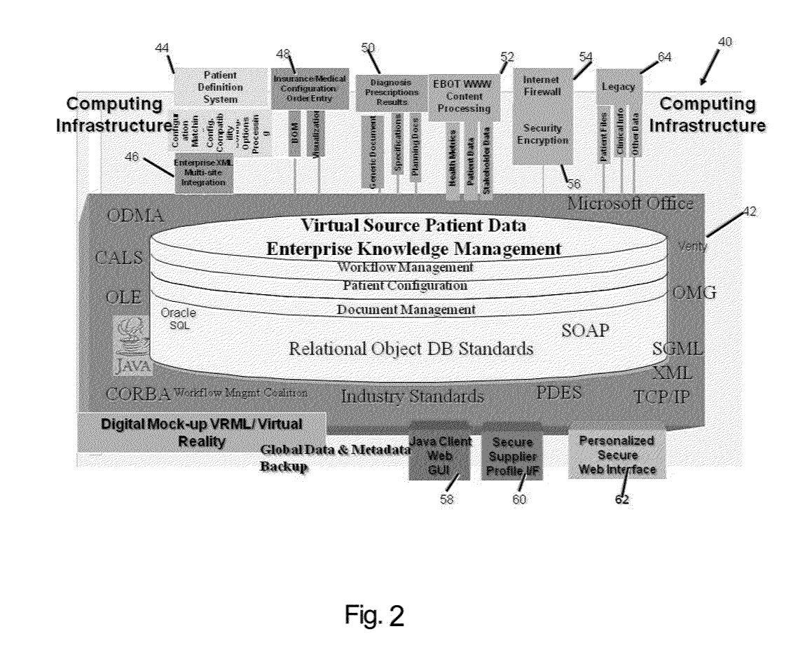

With reference to FIG. 2, there is shown the Internet system 10 computing infrastructure generally designated 40 that correlates, compiles, configures, oversees, implements, manages and/or controls the various aspects thereof. The computing infrastructure 40 includes an object oriented program management structure 42 that is tied together based on relational object database standards such as Oracle or SQL. Within the program management structure 42, workflow management, health profile, configuration management and document management take place based on various operating environments indicated in the Figure.

The computing infrastructure 40 supports health profile definition system 44 having configuration matching, configuration compatibility, and configuration options processing. The health profile definition system 44 is supported by an enterprise XML multi-site integration 46 that ties the definition system 44 to the program management structure 42. The computing infrastructure 40 also includes an insurance/medical configuration/order entry 48 having BOM and visualization that is integrated with the program management structure 42. As well, diagnosis, prescription and results 50 also forms part of the computing infrastructure 40. Within the diagnosis, prescription and results 50 is generic patient documents, specifications, and planning documents.

The computing infrastructure 40 of the present system (the Internet health data system) also includes ebot WWW (internet) content processing 52 for content located. Such content processing includes individual health chain metrics, and health information broker to push information on related needs to specific stakeholders. As the ebot, knowbot or spider navigates the Internet for gathering content, the content located must be processed for the appropriate user (doctor, patient, etc.,) and any other criteria in order to make the same available to the user via the various profiles. As well, since the present Internet System 10 is preferably applied through the Internet, the computing infrastructure 40 includes a firewall 54 with appropriate security encryption 56, as are generally known in the art. Additionally, the computing infrastructure 64 includes an appropriate legacy environment 64 that includes patient files, programs and data.

In order for the user to be able to access and communicate with the Internet System 10 via the Internet (web), the computing infrastructure 40 includes a graphical user interface (GUI) 58 that is preferably Java and XML enabled. Additionally, a secure supplier profile interface 60 is provided that allows content material supplier to securely send, rescind, and/or edit any content material in accordance with the established security and procedure for review and/or inclusion to the content the welfare material into the Internet system. As well, the computing infrastructure 40 includes a secure personalized web interface 62 for allowing a user secure access in correlation to their profile, to information retained by the Internet system.

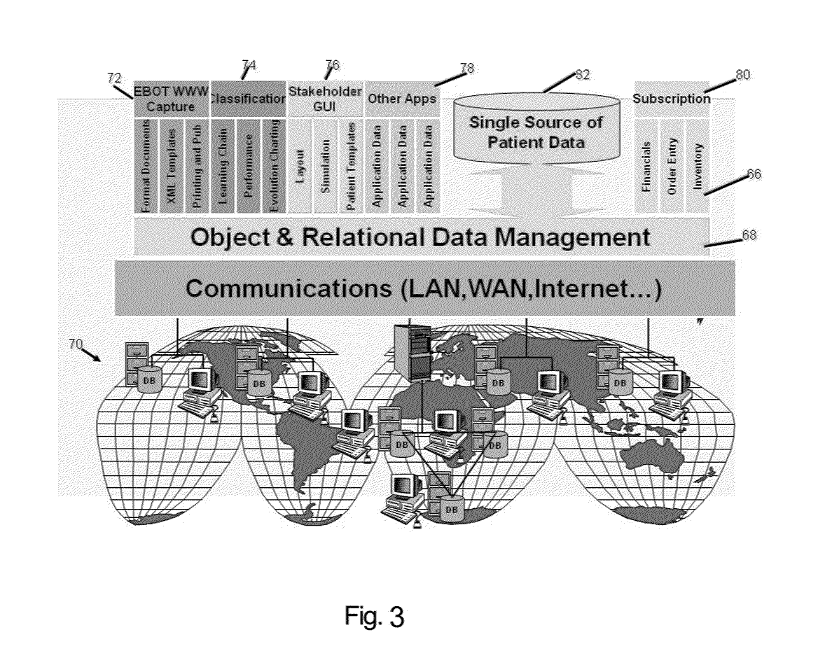

With additional reference to FIG. 3, the Internet system 10 (see FIG. 1) includes framework logic to pull together the various aspects of the object and relational data management system 66 of Internet. As indicated above, the Internet system 10 is coupled to the world's web enabled devices (collectively 70) via various communication methods and/or systems 68. Of course, Internet includes the means necessary to implement the communication types and configurations depicted.

In order to create the single source of individual health data 82 that makes up Internet system, the object relational data management system 66 performs various tasks, some of which are depicted in FIG. 3. Ebot Internet capture 72 is implemented through the object and relational data management section 66. The ebot capture 72 includes patient documents, XML templates, for printing and publication. As well, the object and relational data management system 66 provides classification 74 of the various patient health material from third party suppliers and the like. Such classification includes registration to the location of the information. The Internet system does not need to transfer data to another location. The data item can continue to exist at its original location.

It is expected that various institutions, physicians, hospitals, insurance, pharmaceutical, governmental, and other stakeholders will want to access and use the patient health system herein as implemented over the Internet. The Internet program contemplates profitability through various means such as subscription of third party submissions and/or extractions of patient data, materials, statistical analysis, security assurance and payment for posting/use, advertising, and the like. In the case of subscription, those people, companies and the like who desire to use the Internet system will pay a usage fee 80 for such use. The object and relational data management system 66 includes the ability to track subscription information such as financials, order entry, and inventory of patient material.

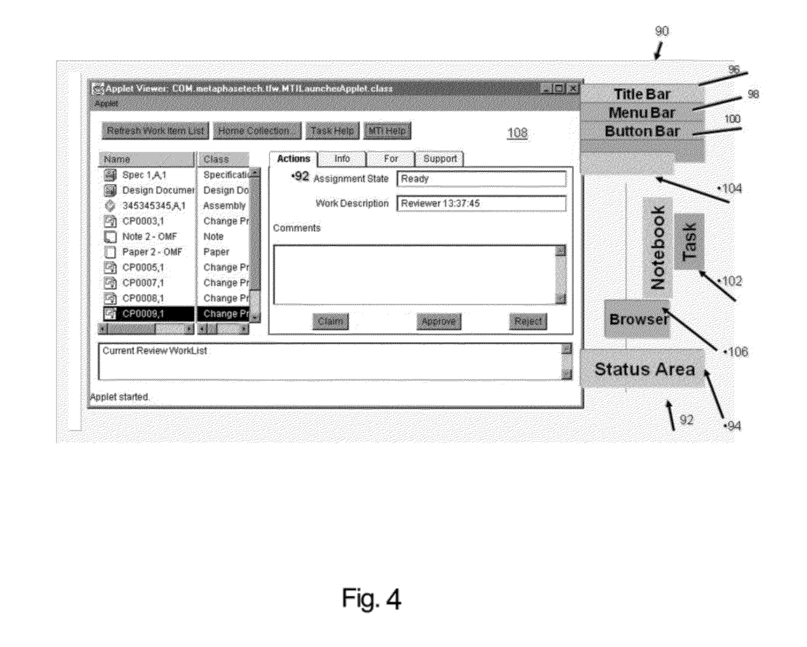

Typically, it is only necessary for the web-enabled device to have a standard Internet browser or similar program in order to avail the user of the information provided by the Internet system. With reference to FIG. 4, an exemplary GUI 90 for access to, implementation and use of the Internet system is shown. It should be appreciated that since the GUI 90 is only exemplary, other styles/configurations may be used. The GUI 90 includes a mode area 92 that is used to select various GUI modes. These modes may include a status area 94, a title bar area 96, a menu bar area 98, a button bar area 100, a task area 102, notebook area 104 and a browser area 104. In addition, the GUI 90 includes a viewing/working area 108 in which the various material is presented.

The GUI 90 may also be used to initiate the system 10 into gathering information or content from the Internet for pushing or providing the content to the user. As such, the GUI 90 may include a semantic engine to aid the system 10 in retrieving content from the Internet, filtering the content according to the user's profile and provide the content to the user. As well, the system 10 may reformat the content as per the user's hardware profile in order that the filtered or edited content gathered from the Internet may be displayed on the user's system.

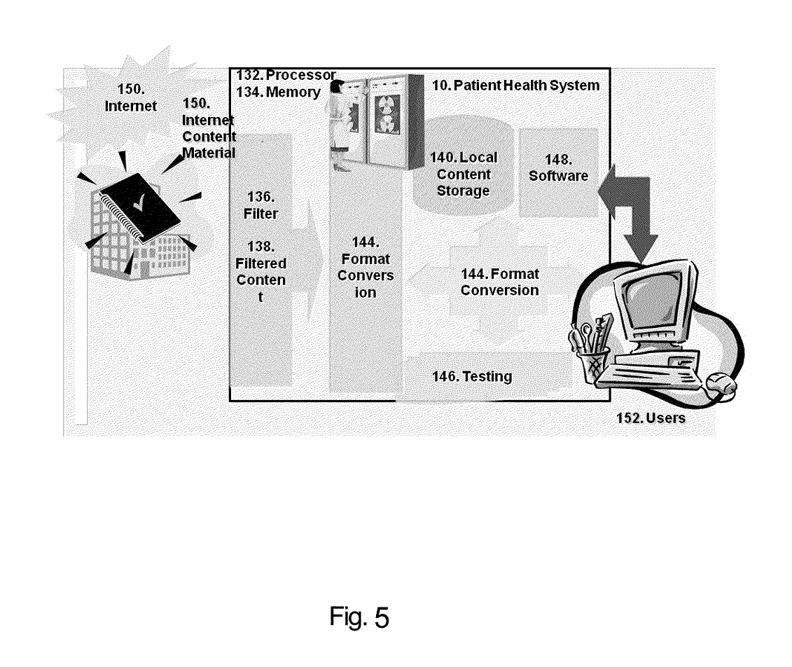

Referring to FIG. 5, a simplified block diagram of the system 10 is shown in accordance with an aspect of the subject invention. The system 10 includes a processor 132 and memory 134 that stores or contains program instructions to run or operate the subject invention in the manner set forth herein. While not shown, the processor 132 is in communication with the various components or modules of the system 10. The system 10 includes a filter 136 that receives Internet content and/or patient data 150. The filter 136 edits and/or parses the content according to the user's profile and/or the user's level of diagnosis within a health plan or simply the patient's current data with respect to a chosen health subject. This becomes the filtered content 138. The filtered content 138 may be stored in a content storage device 140 for later use. Later use may constitute re-presenting the content to the user if necessary, either in the same or different format. Later use may constitute providing the content to another user. The line to the user 152 represents both conditions.

The filtered health content 138 may be directly provided to the user (as represented by the line connecting the filtered content 138 to the user 152) or may be converted into another format for presentation or providing to the user 152. Format conversion 144 is operative to take the format of the content and convert it to another form. The converted form content from the format conversion 144 may be stored in the content storage 140 or provided directly to the user 152. Additionally, the system 10 includes software 148 that may be provided to the user to allow the subject invention to operate.

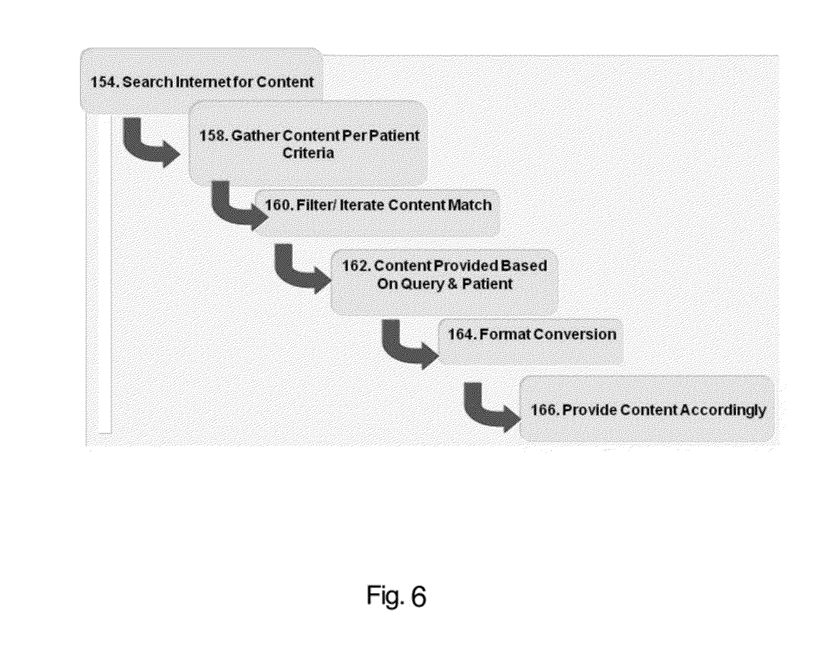

Referring to FIG. 6, there is depicted a flow chart, generally designated 154, of an exemplary manner of an aspect of operation of the subject invention. Initially, in step 156, the system 10 searches the Internet for content. As explained above, content may be selected by the system 10 in response to an established health plan, or may be selected by the user preferably with the aid of the GUI 90. In step 158; content is gathered by the system 10 according to various criteria such as the user's health profile and/or hardware profile and subject matter. Content format may be a criterion. In step 160, the system 10 filters the content appropriately with regard to the various criteria. In step 162, the content is correlated to the profile(s) of the user. In step 164 the content is formatted accordingly if necessary. Thereafter, in step 166, the content is provided to the user preferably via the Internet.

Referring to FIG. 7, the enterprise may consist of the client tier, the middle tier, and the EIS (Enterprise Information Systems) tier. The system 10 may be comprised of the middle tier and the EIS tier. The client tier represents the various users of the system 10. The EIS tier is the top tier that contains or is operative to provide the various information systems architecture or programming. The EIS tier interfaces with the middle tier that consists of an EJB (Enterprise Java Bean) container, a web container and a JNDI, JMS and SOAP mail architecture module. The EJB container contains a plurality of enterprise beans that interface with a client, the enterprise information systems, and the web container. The web container includes servlets, JSP pages, HTML, and XML programs/programming that encapsulates the Health data provided by patients, caregivers and other stakeholders. The clients may interface with the web container if appropriate.

In FIG. 7, an exemplary web container is depicted. The web container may be a Java 2EE container that includes an application dispatcher module, a view rendering module, a web actions module, a business data module, a view-processing module, and an enterprise services module. These modules interact to provide a client with content as provided herein. The J2EE web container also interacts with the EIS, again to provide content to user.

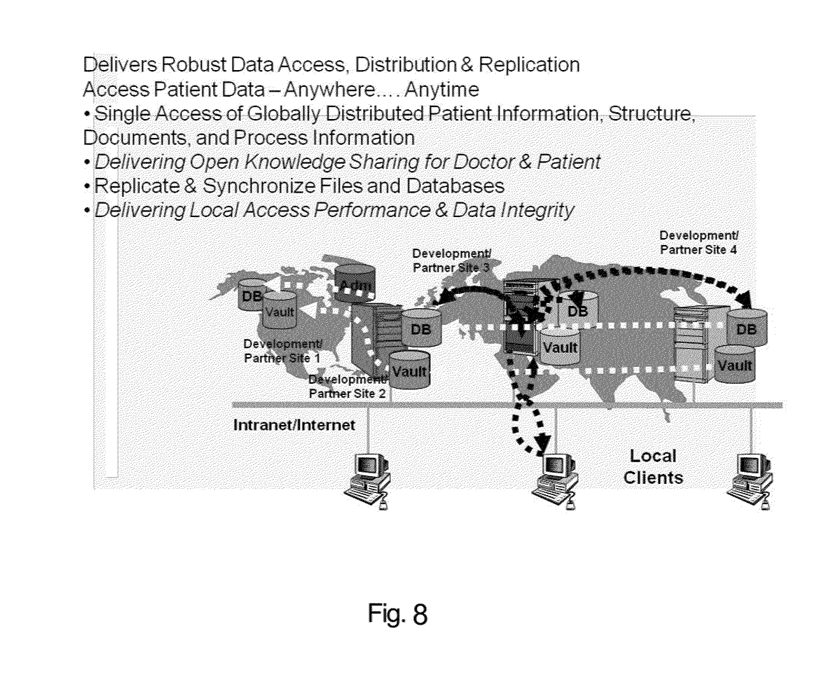

FIG. 8 summarizes the global nature of the Solution and the underlying technology for rapid retrieval and dissemination of patient health data to the right people at the right time.

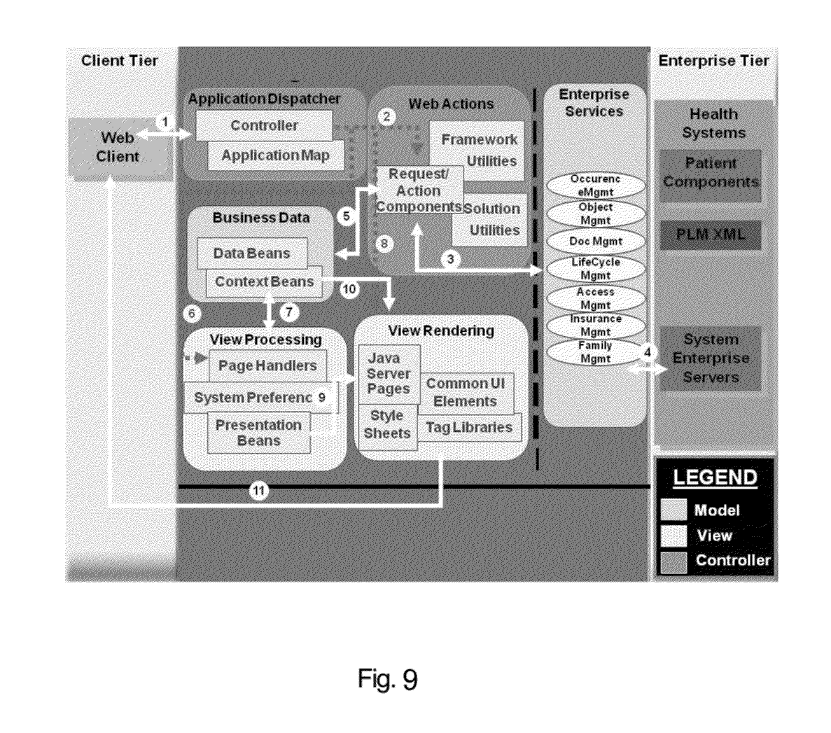

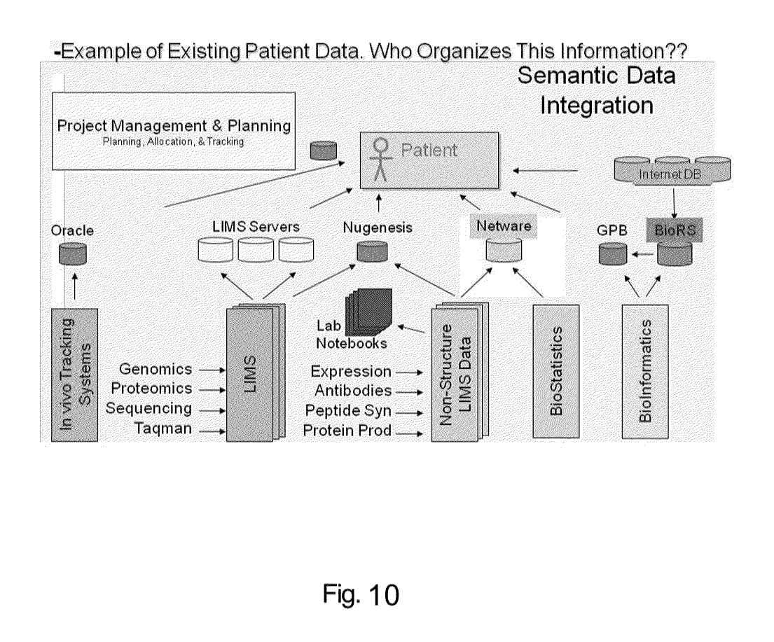

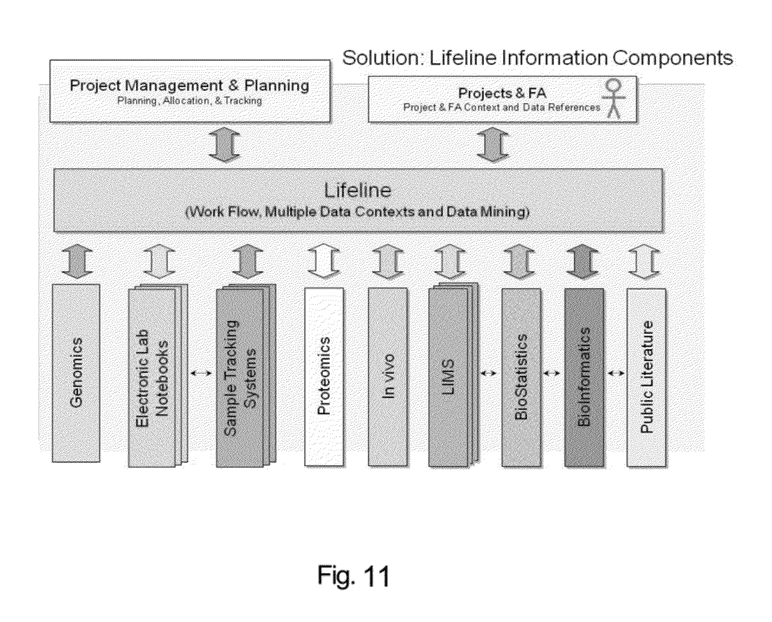

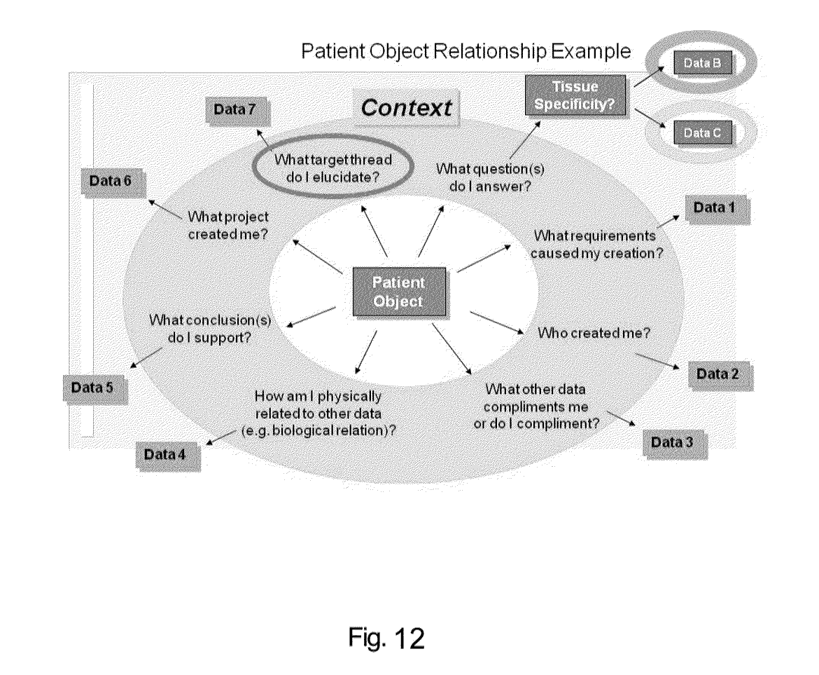

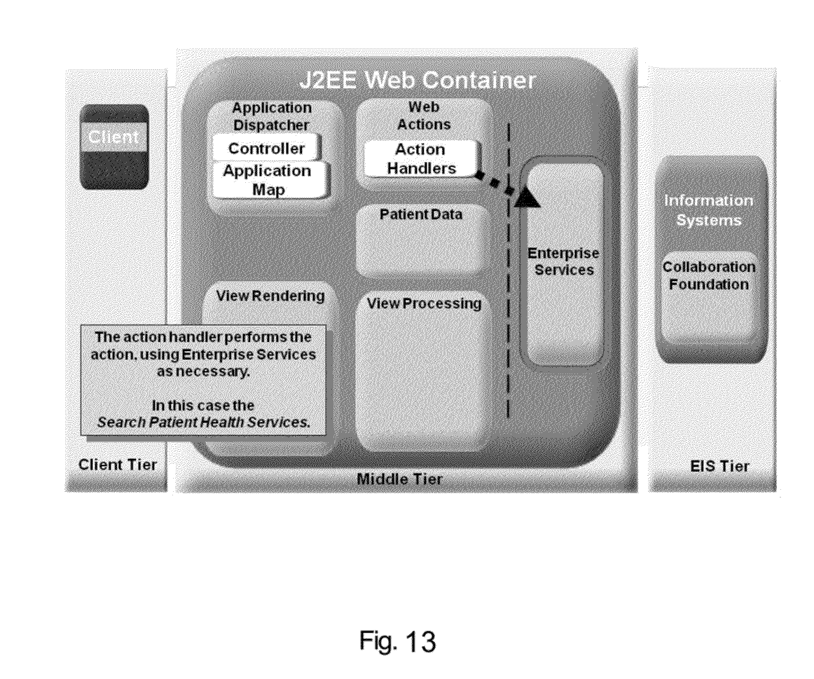

Referring to FIGS. 9-16, there is depicted an exemplary manner of operation (application flow) with respect to the exemplary embodiment of the enterprise/system 10 depicted in FIGS. 7 and 8. In FIG. 9, the system 10 controller looks into the application map to find an action to invoke for a given URL request from the client. In this case, the application map (application_map.xml) finds the search action handler to invoke. It should be appreciated that the exemplary manner of operation may be extrapolated to a content search and retrieval for a subject. In FIG. 13, the controller, having found the requisite action, invokes the appropriate action handler using information from the application map. In this case, the appropriate action handler is the search action handler.

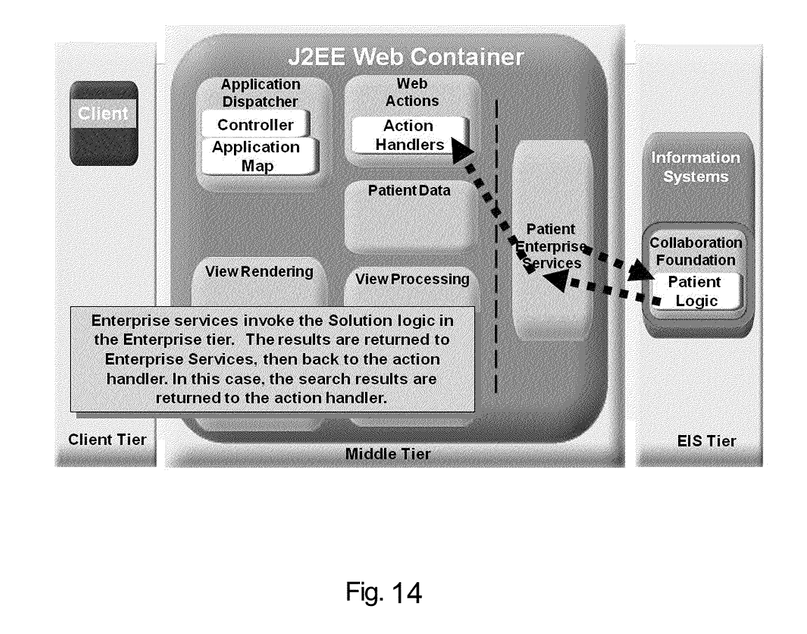

In FIG. 14, action handler performs the particular action requested, using the enterprise services as necessary. In this case, the enterprise service is the Internet system. The enterprise service invokes the Internet system logic in the enterprise tier as depicted in FIG. 1. The Internet information systems utilize profile logic to perform a search, the results of which are returned to the enterprise services, then back to the action handler. In the present instance, the search results are returned to the action handler.

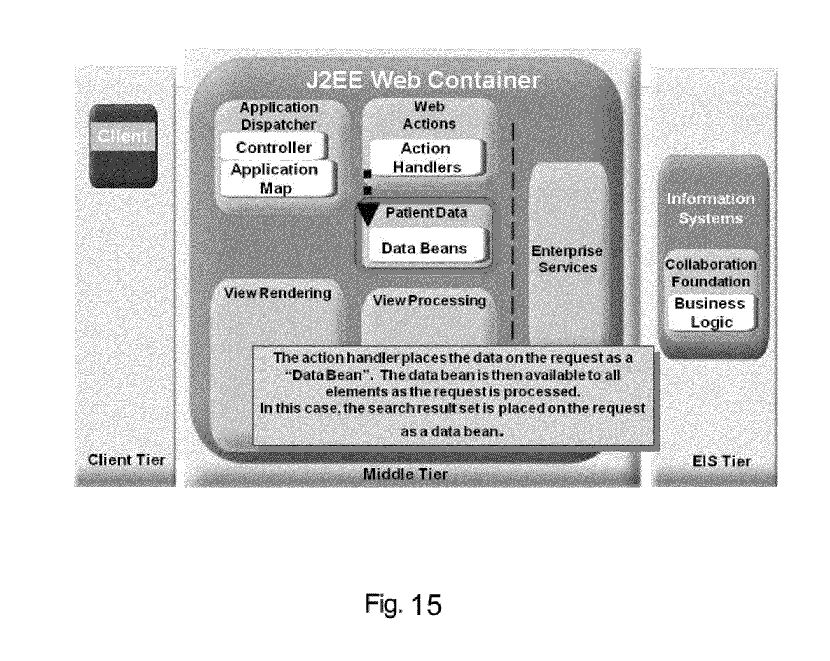

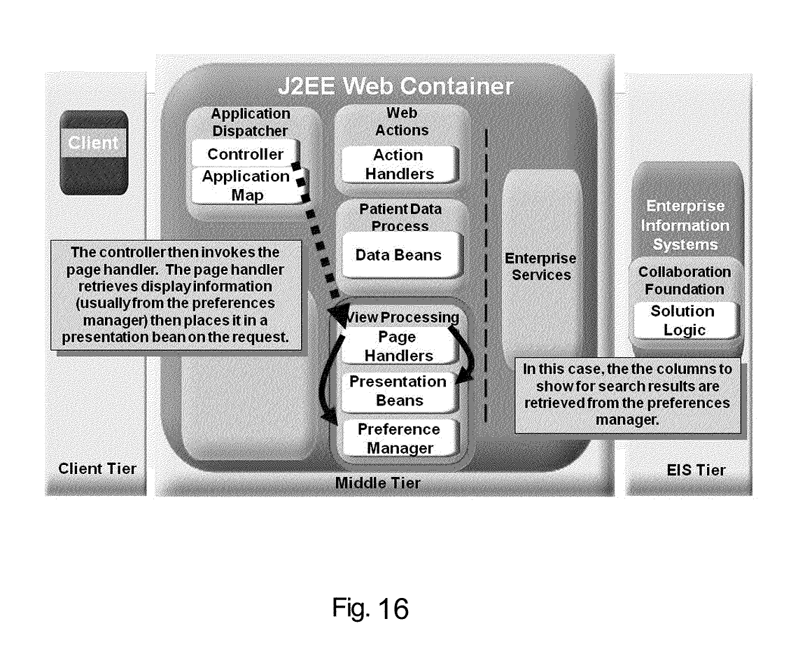

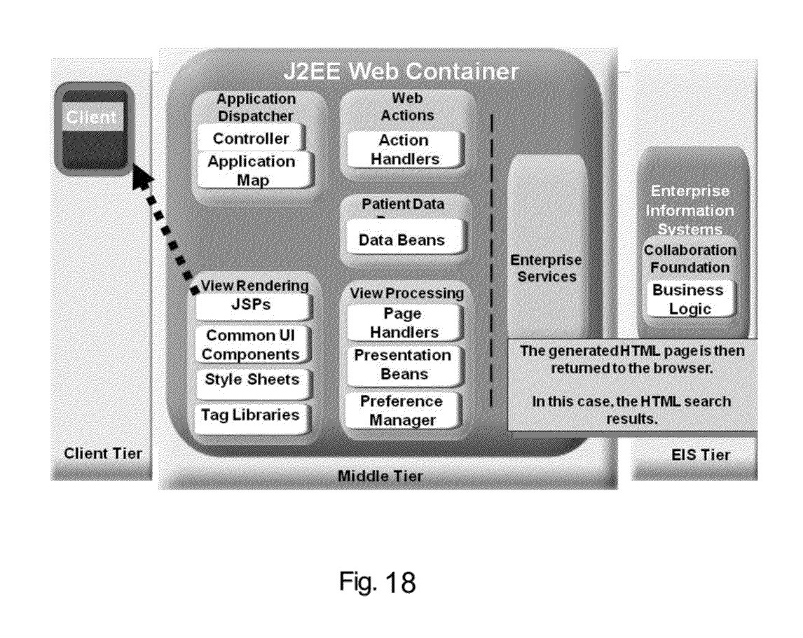

In FIG. 15, the action handler places the data on the request as a “data bean.” The data bean is then available to all elements as the request is processed. In the present case, the search result set (content) is placed on the request as a data bean. The controller then invokes the page handler as illustrated in FIG. 14. The page handler retrieves display information (usually from a preferences manager) then places the display information in a presentation bean on the request. In the present instance, the columns for the search results are retrieved from the preferences manager. In FIGS. 16 & 17, the controller invokes the JSP. The JSP then reads the data and presentation beans for the information to generate the HTML (or other format as appropriate for the user). The JSP page may make use of style sheets, JSP tag libraries, and other UI elements. In this case, the JSP page generates the search retrieval results. Lastly, in FIG. 18, generated HTML page is then returned to the browser of the client (user). In the present case, the HTML page is the HTML search results.

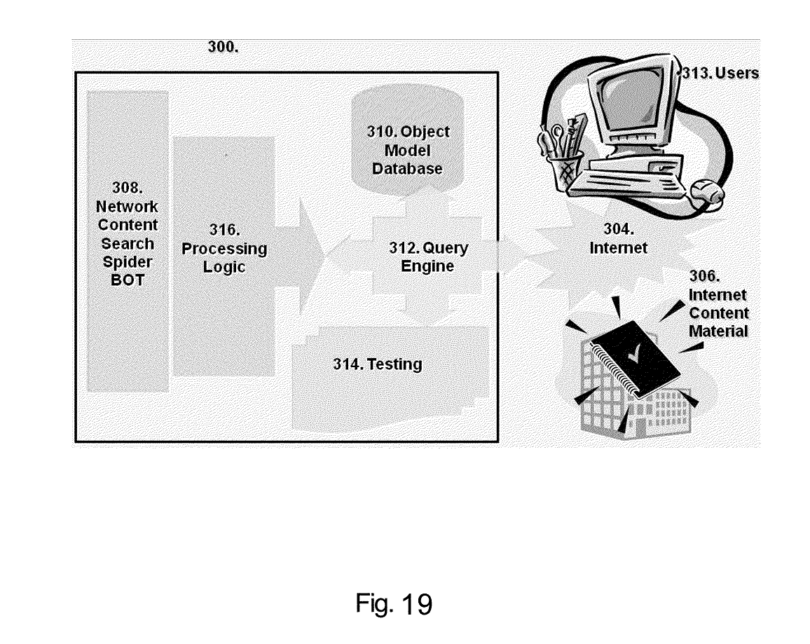

Referring now to FIG. 19, there is depicted another exemplary embodiment of a system, generally designated 300, that is functional to operate in the manner set forth herein with respect to the system 1 of FIG. 1 and/or with respect to that described below. Therefore, it should be appreciated that the system 300 may incorporate the functionality of the system 1 of FIG. 1 and, preferably, incorporates at least some if not all of the functionality of the system 1 of FIG. 1.

The system 300 includes the Internet system 302, a network such as the Internet 304 having Internet content and/or material 306, and a user or users 313. The Internet 304 in FIG. 16 is thus representative of any type of network, similar or not. The Internet patient health content/material (collectively hereinafter, “content”) 306 is thus representative of the many pages or sources of data or information associated with or on the Internet 304. The system 302 is in mutual communication with the Internet 304 and thus in mutual communication with the Internet content/material 306 and the users 313.

The system 302 includes among other features and/or functions not shown or described below, a network content search or scan spider, bot or the like 308, an object model database 310, processing logic 316, a query engine 312 and testing 314. Each block or module is representative of a feature, function, software and/or hardware implementation of the named block. Moreover, while not specifically shown, the various blocks of the system 302 work together as described herein.

The network content search bot 308 is operative, adapted and/or configured to search and/or scan the Internet 304 for health content and/or material (hereinafter collectively, content). The content may be regarding any topic, subject or the like or may be a specific topic. The content will be made available to Internet stakeholders depending on their profile preferences and requests. The content search bot 308 may look only for specific content (i.e. content regarding a particular subject), a particular level of a specific topic, or any topic and/or level thereof. The content search bot 308 is operative to search or scan the Internet 304 “on the fly” (when specifically requested to find material regarding a health topic of subject) or regularly to mine content. By example, the content search bot 308 looks at content stored on the Internet 304 and gathers data regarding the content. The content data is processed by the processing logic and/or stored as data in the object model database 310. The network content/search bot 308, by itself or in conjunction with processing logic 316, gathers, assembles and/or compiles data regarding the content and/or attributes, characteristics and/or the like of the content. This content data is stored in the object model database 310.

The content 306 resides on or is a part of an Internet page, site, area or the like (i.e. one or more files on a computer, file server or the like, and collectively “Internet page”). The content 306 may be considered as and typically is the assemblage of data and/or information contained on an Internet page. Each Internet page contains one or more types of content. For example, Internet page “A” may contain text only. While Internet page A contains only one type of content, which is text, the form (e.g. letters) of the text itself has attributes or characteristics such as style, font and size. The text also has attributes such as subject matter, format, reading level and the like. Thus, each type of content has attributes that can be classified, catalogued and/or categorized. As a further example, Internet page “B” may contain pictures, text, graphics, active components like CAT Scans, MRI's and the like. Internet page B thus contains many forms of content each one of which has attributes and/or characteristics. It is these attributes, characteristics and/or the like that are utilized, at least in part, to create the Internet solution database (i.e. to create and/or store content data as object model data such as metadata).

The content search bot 308 reads the coding or code of a site in order to ascertain code or coding data such as metadata in the existing code of the site. When coding is XML, for example, tagging of items may be utilized. With XML, the coding identifies the appropriate metadata. This may be used directly by the system 300 or may be processed accordingly. XML sets forth the features, “what is what” and attributes regarding the content. The XML (as well as other coding but not necessarily to the same degree) may be directly used to provide content metadata (data) for the object model database 310. Of course, other coding or code may be read and analyzed, in addition to other particulars, characteristics, attributes of the content data.

The content search bot 308 updates its content data by revisiting Internet pages and, of course, continuing to search or scan the Internet for content. When a site is revisited, the system may compare new data with old data to determine whether the new data needs to be registered/saved. Alternatively, new content data is registered automatically. The object model database 310 also stores registered information regarding the location of the content data.

Particular content is provided to a user 313 by pushing the content to the user. In pushing the content to the user, the system 300 obtains the content via a connection path or channel to the particular site, and then essentially passes the content to the user via another connection path or channel. The system 300 may process, filter, reformat or otherwise process the content before providing it to the user via a providing channel or connection, but preferably just passes through the content. The content has been correlated to the particular user utilizing the user's profile via the object model database (i.e. the structure, function and/or features of the data in the object model database 310, the processing logic 316 and the system 300 in general). Therefore, the system 300 provides the health material (assembled content data) to the user 313.

The query engine 312 of the system 300 is operative, configured and/or adapted to allow a user and/or the system 302 to generate a query for “on the fly” content searching/scanning. This may be utilized for many reasons. The query engine also handles all requests by the system for data and/or information, in the context of providing content to a user and with regard to the system itself. In one form, the query engine may bring back real-time content whose content data has been processed and correlated appropriately as provided herein. The Internet solution 302 may provide real-time data in the normal course of providing health material rather than in response to a query. The real-time content may be provided in addition to or separate from other content.

The processing logic block 316 of the system 300 is representative of logic and/or circuitry that may be software, hardware, firmware or the like and/or any combination thereof, is operative, configured and/or adapted to process data in the manner described herein and/or provide the functionality and/or features of the system 300 as described herein.

The testing block 314 is representative of the ability of the system 302 to provide tests to a user in order to retrieve needed health data, the progress of a patient and the need to update a user's health profile. The tests may be automatically generated, be manually generated or be a combination thereof. Results of testing are used to modify a patient's profile and/or modify the correlation between a user's profile and the content. Tests also increase statistical correlation of information provided as compared to comprehension level.

The testing and user profile/correlation modification is preferably an endless loop of subject and subject level presentation (until the user either accomplishes each level of each subject, topic or goal, or until the user quits the health process). Testing may occur at any time or be scheduled at the end of various health sections. Moreover, testing may be utilized to create and/or update a correlation object that functions to correlate the data in a user's health profile with the content data.

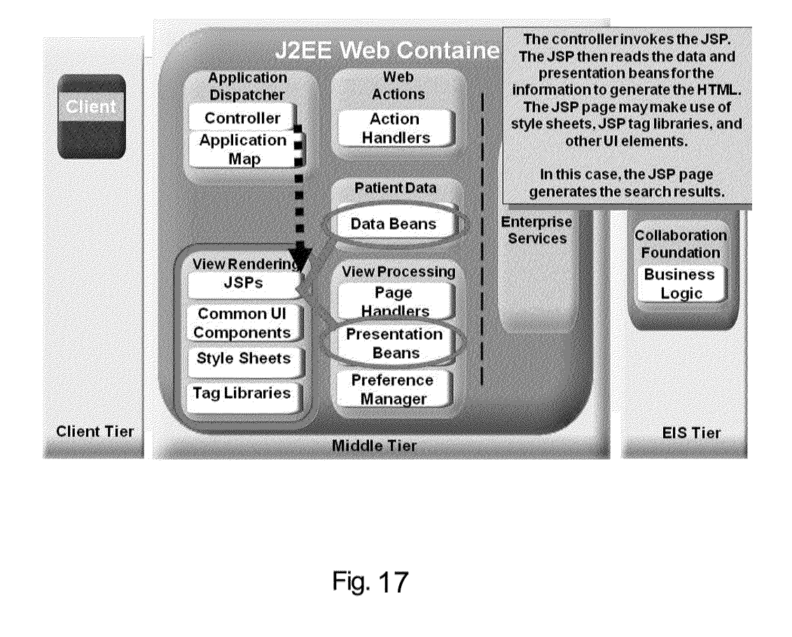

In FIG. 17, an exemplary model of the object model database 310 is shown. The object model database 310 may be considered as having or may be implemented as or in metadata. A metadata file for implementing an object model database 310 or the like is provided on CD-ROM filed with the present application and which is incorporated herein by reference and as a reduced attachment. The object model database 310 may be considered as having a patient profile object model module 320, an Internet content/material object model module 322, a correlation object model module 324 and a security/sharing object model module 326. The object model database 310 may, and preferably does, contain other modules not specifically shown for fulfilling the functionality provided herein.

The patient profile object model 320 stores from one to any number of profiles, typically one profile per user. The profile is obtained as provided herein and is stored as object model or metadata in the object model database 310. Particularly, the total accumulation of patient data, preferences, attributes, characteristics and the like of the user are stored as profile data. In a basic sense, the patient profile data indicates past and present health of the patient. The profile object model 320 is also preferably dynamic. The Internet content/material object model 322 stores the content data. The content data is preferably, but not necessarily, stored as metadata. The content object model is also preferably dynamic.

The correlation object model 324 provides correlation between the content object model 322 and the health profile object model 320. The correlation object model 324 is definable by the system 302 and/or a manager of the system 302. As such, the correlation object model may be changed for various purposes. Various degrees and instances of correlation between a user profile and content is modifiable. In one form, the correlation object model 324 acts as a filter in order to match content to a user based on the user's profile. The user is thereby provided content that correlates in one or more manners in order to tailor the content to the user's abilities. Correlation may change during a patient's life.

FIG. 18 shows the flow and access to the patient data via a secure system of profile management. Herein, data is protected from alteration but can be checked out via a shadow copy for view and/or collaboration. A physician profile would differ from other profiles allowing them to author specific types of data. All relevant information is captured (blood test, MRI, X-ray, etc) registered and attached with XML Meta data to identify its characteristics for Internet solution management.

Referring now to FIG. 19, there is illustrated a flow chart, generally designated 350, setting forth an exemplary manner of providing patient health content in accordance with an aspect of the subject invention. It should, at the outset, be appreciated that the exemplary manner of providing health material described below is a detailed manner of providing material. As such, a manner of providing material that is less detailed and derived from the detailed manner 350 may more than set forth the subject invention. In other words, a subset of steps of the manner 350 can implement the subject invention. Moreover, it should be appreciated that the manner 350 and any and all subsets thereof do not necessarily need to follow the order set forth herein.

In step 352, a user logs onto the system. As indicated above, the user utilizes the Internet or other network to establish communication with the system. Once the user has established communication with the system, in step 354, the system recognizes the user. Recognition of the user may take many forms and/or involve one or more interim steps. By way of example, once a user logs onto the system, the system needs to access whether the users specific profile that contains relevant data. If the user does not have a profile, the system establishes one through interaction with the user.

In practice a user could have differing profiles and therefore access to Internet solution data. The profile for a hospital admissions representative would allow transfer of patient data, insurance data and the like to populate on admissions XML document. This same person would also be profiled for total view only access to their personal and/or children's information. The latest LDAP, multi-level identity security will be used.

In step 356, the system provides a graphical user interface (GUI) or similar manner of providing information and allowing a user to interact and/or make selections or choices. The GUI may be as that presented above. In any case, the GUI provides the user with several selections or choices regarding many facets of the system, the user's account, and the providing of health material. The GUI may offer on the fly queries for subject matter in addition to providing a curriculum of subject matter. The user may access options via the GUI. The GUI may provide other features and/or functions.

Assuming that the user selects to begin with the health mode, in step 358 the system provides health content to the user. The system correlates content with the user's profile and pushes the content to the user. Particularly, the system correlates the health proclivities and/or preferences with content of the particular subject matter and correlated to the health proclivities and/or preferences.

The present Internet health data system is designed to eliminating inefficient and error-prone paper processes through a fully integrated infrastructure that not only ensures consistent care among clinicians, but also supports the improvement of consumer health and quality measurement.

The present Internet health data system is further designed to link patients and their health care providers via secure Internet connections. Personal health record capabilities of the present system empower people to be proactive in maintaining good health and gives easy, quick access to vital patient data, lab results and drug interaction checking. With this technology, health care organizations can not only meet the IOM's and HIPAA mandates for improving consumer health, but also provide themselves with a valuable business strategy for the 21st century.

In step 360, the system assesses the degree of user understanding of the content. This may be done by testing or other means. The assessment may be provided at various levels along the health chain for the particular content or subject matter. The assessment outcome is utilized to modify the user's health profile and/or the user's correlation model and, in step 362, the health profile, correlation model and/or other data/information is adjusted or modified accordingly. Subsequent content is provided according to the modified health profile and/or correlation model. This process may be an endless loop of subject and subject level presentation or up to a particular level or goal.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the claims hereafter.

1. (canceled)

2. (canceled)

3. (canceled)

4. (canceled)

5. (canceled)

6. An Internet-based health data system comprising:
an Internet server in communication with the Internet;
object-oriented programming implementing a health database through the Internet server,
a patient health profile implemented on and maintained in the health database;
Internet search programming implementing an Internet searching tool on the Internet server that automatically searches Internet web sites and identifies health content independent of the health database and pertaining to the stored patient health profile; and
Internet retrieval programming implementing an Internet data retrieval tool on the Internet server that retrieves the identified health content from the Internet and stores the retrieved health content in the health database.

7. The Internet-based health data system of claim 6, further comprising:
programming on the Internet server that regulates retrieval of the identified health content based upon regulatory provisions via a role based security system.

8. The Internet-based health data system of claim 7, further comprising:
programming on the Internet server that allows input of health and wellness data into the health database by a patient via the role based security system.

9. The Internet-based health data system of claim 8, wherein the programming on the Internet server that allows input of health and wellness data into the health database by the patient further allows input of health and wellness data into the health database by patient designated caregivers and representatives via the role base security system.

10. The Internet-based health data system of claim 9, wherein the patient designated caregivers and representatives comprise insurance representatives, pharmaceutical representatives, dental representatives, and genetic representatives.

11. The Internet-based health data system of claim 8, wherein the programming on the Internet server that regulates retrieval of the identified health content based upon regulatory provisions via a role based security system further regulates retrieval of levels of the identified health content based upon regulatory provisions via the role based security system.

12. The Internet-based health data system of claim 11, further comprising:
programming on the Internet server that allows selective input of data regarding the retrieved level of the identified health content.

13. The Internet-based health data system of claim 6, further comprising:
programming on the Internet server that captures metadata for the health database relating to input and output within the health database in accordance with legislative parameters.

14. The Internet-based health data system of claim 6, wherein access to the health database is restricted to viewing only.

15. The Internet-based health data system of claim 6, further comprising:
programming that provides notification to a patient in the health database in response to a predetermined alert and caregiver notification.

16. The Internet-based health data system of claim 6, wherein health data and metadata is maintained against a chronological scale for lifecycle analysis of a patient in the health database.

17. The Internet-based health data system of claim 6, further comprising:
programming that provides maintenance of the health database for non-specific data analysis to evaluate statistical parameters of available data.
